(19) United States
(12) Patent Application Publication
(10) Pub. No.: US 2009/0046670 A1
(43) Pub. Date: Feb. 19, 2009

(54) Method for Data Transmission in a Radio Communication System

(76) Inventors: Iwajlo Angelow, Wroclaw (PL); Volker Breuer, Botzow (DE); Mieszko Chmiel, Glucholazy (PL)

Correspondence Address: STAAS & HALSEY LLP, SUITE 700, 1201 NEW YORK AVENUE, N.W., WASHINGTON, DC, 20005, US

(21) Appl. No.: 12/083,919

(22) PCT Filed: Oct. 11, 2006
(86) PCT No.: PCT/EP2006/067295

§ 371 Date: Apr. 21, 2008

(30) Foreign Application Priority Data
Oct. 20, 2005 (EP) 05460029.1

(51) Int. Cl. H04J 3/00

(52) U.S. Cl. 370/336

(57) ABSTRACT

A method for data transmission in a radio communication system, in which data of a plurality of subscribers is combined with the aid of a multiplexing method to form frames, and is transmitted by means of sub-carriers. At least two frame structures are provided for transmission of the frames, with the frame structures differing in the respectively associated number of pilot signals and/or in the distribution or grouping of associated pilot signals. Each subscriber determines an individual progress speed, and each subscriber is allocated to one of at least two speed ranges, depending on the progress speed. A frame structure which is individually associated with the speed range, on the one hand, and an individually associated number of sub-carriers, on the other hand, are used in order to transmit the data from subscribers who are allocated to an identical speed range on the basis of their progress speed.

### CROSS REFERENCE TO RELATED APPLICATIONS

This application is based on and hereby claims priority to application number PCT/EP2006/067295 filed on Oct. 11, 2006, and European Application No. 05460029, filed Oct. 20, 2005, the contents of which are hereby incorporated by reference.

### BACKGROUND

The invention relates to a method for data transmission in a radio communication system.

Radio communication systems are known in which identical carrier frequencies are used as radio transmission resources in adjacent radio cells. Considered over the radio cells, this results in a so-called “frequency reuse” of “one”.

This type of allocation is used, in particular, in the so-called “OFDM radio communication systems” in which adjacent radio cells use identical subcarriers for radio transmission. A plurality of subcarriers of a system can be combined to form a so-called “frequency chunk”.

In OFDM radio communication systems, subcarriers are also subdivided into time domains. Each time domain of a subcarrier then forms a radio transmission resource called “frames”.

A broadband development of the known UTRA radio transmission standard is called “evolved UTRA, E-UTRA”. In this context, both “time division duplex, TDD” transmission methods and “frequency division duplex, FDD” transmission methods or their combinations, respectively, are to be supported for radio transmissions. In the E-UTRA standard, OFDM radio transmission techniques are also used.

FIG. 1 shows by way of example radio transmission resources of a transmission technique called “FDD only”, “TDD only” and “combined FDD/TDD”.

In the transmission technique called “FDD only”, different frequency bands are used simultaneously both for transmissions from a subscriber station to a base station and for transmissions from the base station to the subscriber station. For the direction from subscriber station to base station, called uplink UL, a frequency band f_{UL} is used whereas a frequency band f_{DL} is used for the direction from base station to subscriber station, called downlink DL. This transmission technique provides the advantage of very high data transmission rates.

In the transmission technique called “TDD only”, a common frequency band f_{DL}=f_{UL} is used for transmissions in the direction from subscriber station to base station, called uplink UL, and for the direction from base station to subscriber station, called downlink DL. Four time domains or time slots are shown for transmissions in the downlink DL direction and four time domains or time slots are shown for transmissions in the uplink UL direction, for example, which alternately follow one another.

In the transmission technique called “combined FDD/TDD” or also “half duplex FDD”, the “TDD only” and “FDD only” transmission methods are combined. Shown here are by way of example four time domains or time slots for transmissions in the uplink UL direction in the associated frequency band f_{UL} and four time domains or time slots for transmissions in the downlink DL direction in the associated frequency band f_{DL}. In “combined FDD/TDD”, it is possible to achieve simplified receiver structures at a subscriber station called “user equipment, UE”. FIG. 3 shows radio transmission resources FR, called “chunk”, of an OFDM radio communication system or E-UTRA radio communication system, respectively.

In this arrangement, so-called “subcarriers” are plotted along a horizontal frequency axis f whilst time sections or time domains are plotted along a vertical time axis t.

By way of example, twelve radio transmission resources FR are here allocated to a first subscriber A whilst a total of six radio transmission resources FR are allocated to a second subscriber B. Furthermore, a total of nine radio transmission resources FR are allocated to a third subscriber C and a total of five radio transmission resources FR are allocated to a fourth subscriber D.

FIG. 4 shows a first frame structure of the E-UTRA radio transmission, taking place frame by frame, for a subscriber who does not change his geographic position or changes it with a low speed of progress, respectively.

A “subframe” frame has a time duration, called “subframe duration”, of 0.5 ms. Within the “subframe” frame, a total of four “data” time domains are provided which can be used for transmitting useful data of subscribers. In this arrangement, the “data” time domains of the “subframe” frame are allocated to one or more subscribers with the aid of a multiplexing method.

Furthermore, a “pilot” time domain is provided which can be used for transmitting a pilot signal. The pilot signal makes it possible to determine characteristics of radio transmission channels, by estimation if necessary.

To be able to distinguish the subscriber time domains “data” and the pilot signal time domain “pilot” mentioned, a so-called “cyclic prefix, CP” is transmitted in further five time domains CP. FIG. 5 shows a second frame structure of the E-UTRA radio transmission, occurring frame by frame, for a subscriber who changes his geographic position with a medium speed of progress.

The “subframe” frame has a time duration, called “subframe duration”, of 0.5 ms.

Within the “subframe” frame, a total of four “data” time domains are provided which can be used for a transmission of useful data by subscribers. In this arrangement, the “data” time domains of the “subframe” frame are allocated to one subscriber or to a plurality of subscribers with the aid of a multiplexing method.

Furthermore, two “pilot” time domains are provided as so-called “short blocks” which can be used for transmitting two pilot signals. The two pilot signals make it possible to determine characteristics of radio transmission channels, by estimation if necessary.

To be able to distinguish the “data” subscriber time domains and the two “pilot” pilot signal time domains mentioned, a so-called “cyclic prefix, CP” is again transmitted in further six time domains CP.

FIG. 6 shows a third frame structure of the E-UTRA radio transmission, occurring frame by frame, for a subscriber who changes his geographic position with a high speed of progress.

The “subframe” frame has a time duration, called “subframe duration”, of 0.5 ms.

Within the “subframe” frame, a total of four “data” time domains are provided which can be used for a transmission of useful data by subscribers. In this arrangement, the “data” time domains of the “subframe” frame are allocated to one subscriber or to a plurality of subscribers with the aid of a multiplexing method.

Furthermore, three “pilot” time domains are provided as so-called “short blocks” which can be used for transmitting pilot signals. The pilot signals make it possible to determine characteristics of radio transmission channels, by estimation if necessary.

To be able to distinguish the “data” subscriber time domains and the “pilot” pilot signal time domains mentioned, a so-called “cyclic prefix, CP” is again transmitted in further seven time domains CP.

The different frame structures, shown in figures FIG. 4, FIG. 5 and FIG. 6, are needed because in each case different numbers of pilot signals are necessary for an accurate channel estimation in dependence on an individual speed of progress of the subscriber with which he changes his geographic position.

According to technical specification TR 25.913, Chapter 7.3, it is intended to support, in particular, three speed ranges in E-UTRA radio communication systems.

A first speed range for “low speeds” comprises the interval from 0 km/h to 15 km/h, a second speed range for “medium speeds” comprises the interval from 15 km/h to 120 km/h, and a third speed range for “high speeds” comprises the interval from 120 km/h to 350 km/h.

If a subscriber considered changes his individual speed, a continuously changing allocation of the frame structure of associated radio transmission resources is currently provided.

This continuously changing allocation of the frame structure leads to problems, in particular, if a plurality of subscribers must be combined in one frame structure by using a multiplexing method.

If a subscriber of a group combined by multiplexing changes his speed, the allocation of the group to a common frame structure is not optimal for all subscribes of the group.

Depending on the selected speed of progress of a subscriber considered, the associated frame structure or the pilot signal distribution determined thereby for this subscriber also influences the channel estimation. In turn, a transmission quality and/or transmission data rate is dependent on the accuracy of the channel estimation for each subscriber.

### SUMMARY

It is one possible object, therefore, to specify a method for assigning radio transmission resources in a radio communication system in which useful data can be transmitted by subscribers frame by frame and by using subcarriers, by which method an optimized subscriber useful-data transmission can be carried out.

The inventors propose a method in which, data of a plurality of subscribers are combined to form frames with the aid of a multiplexing method and are transmitted by subcarriers. At least two frame structures are provided for transmitting the frames, wherein the frame structures differ in a respective allocated number of pilot signals and/or in a respective distribution or grouping of allocated pilot signals, wherein the pilot signals can be used for determining radio transmission channel characteristics.

According to the proposed method, an individual speed of progress is determined by each subscriber and each subscriber is allocated to one of at least two speed ranges in dependence on his speed of progress.

For transmitting the data of subscribers who are allocated to an identical speed range due to their speed of progress, a frame structure individually allocated to the speed range, on the one hand, and an individually allocated number of subcarriers, on the other hand, is used.

If the frame structures have an identical number of pilot signals but which are differently distributed or grouped, this embodiment is advantageous particularly at high speeds.

In an advantageous development, a first frame structure is allocated to a first speed range, the first frame structure having two pilot signals in predetermined two time domains. This first frame structure is particularly suitable for the data transmission of subscribers who have a lower individual subscriber speed.

Correspondingly, a second frame structure is allocated to a second speed range, the second frame structure having three pilot signals in predetermined three time domains. This second frame structure is particularly suitable for the data transmission of subscribers who have a higher individual subscriber speed.

In an advantageous development, useful data of subscribers who, due to their individual subscriber speed, are allocated to an identical speed range are transmitted with little control complexity with the aid of a multiplexing method together in a common frame called “subframe”.

Due to the frame structure selected in dependence on the speed range, an accurate channel estimation, which can be adapted to the speed, is possible via the respective pilot signals of the frame structure.

Due to the proposed method, radio transmission resources or subcarriers or “chunks” are always assigned in optimized manner with little control complexity.

“Chunks” or radio transmission resources can be adaptively allocated to respective speed ranges in a particularly advantageous manner in dependence on a radio traffic volume and/or on predominant individual subscriber speeds.

In a further advantageous embodiment, the subcarriers or frequency domains allocated to the speed ranges are not coherently selected. This advantageously results in a subdivision of the frequency domain or of the subcarrier allocation from the total number of subcarriers or “chunks” which use the in each case one frame structure adapted to a particular speed.

The method provides for effective multiplexing particularly for car drivers who continuously change their respective speed in adaptation to the road traffic situation.

With continuous change in the individual speed of progress of a subscriber considered, it is not necessary to continuously change a frame structure within a subcarrier which would otherwise prevent effective multiplexing of the subscriber considered with other subscribers.

The inventors propose that one frame structure per subcarrier is retained. A subscriber is only placed onto another subcarrier if this has an optimum frame structure for the individual speed of progress of the subscriber.

Thus, only a subscriber changing with respect to speed is optimally adapted by displacement. Further subscribers combined in the same domain by multiplexing methods remain untouched by the change or altered allocation.

### BRIEF DESCRIPTION OF THE DRAWINGS

These and other objects and advantages of the present invention will become more apparent and more readily appreciated from the following description of the preferred embodiments, taken in conjunction with the accompanying drawings of which:

FIG. 1 shows a division and allocation of radio transmission resources according to the method proposed by the inventors,

FIG. 2 shows the radio transmission resources, described initially, of an “FDD only”, a “TDD only” and a “combined FDD/TDD” transmission technique,

FIG. 3 shows the radio transmission resources, described initially, of an OFDM and E-UTRA radio communication system, respectively,

FIG. 4 shows the first frame structure, described initially, of an E-UTRA radio transmission for low subscriber speeds,

FIG. 5 shows the second frame structure, described initially, of an E-UTRA radio transmission for medium subscriber speeds, and

FIG. 6 shows the third frame structure, described initially, of an E-UTRA radio transmission for high subscriber speeds.

### DETAILED DESCRIPTION OF THE PREFERRED EMBODIMENT

Reference will now be made in detail to the preferred embodiments of the present invention, examples of which are illustrated in the accompanying drawings, wherein like reference numerals refer to like elements throughout.

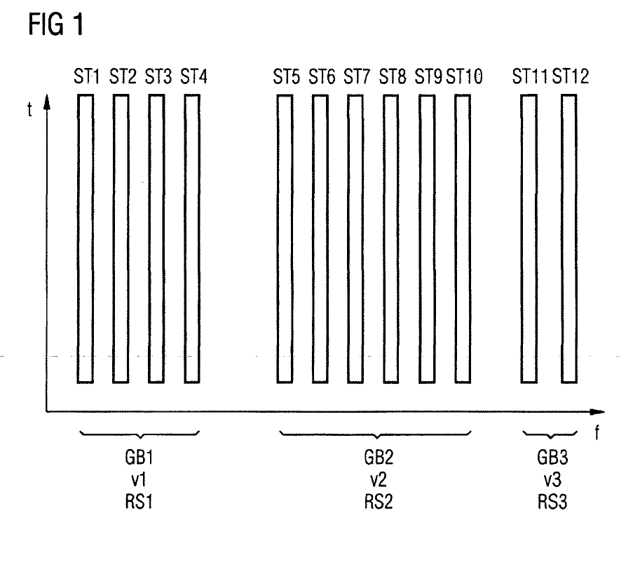

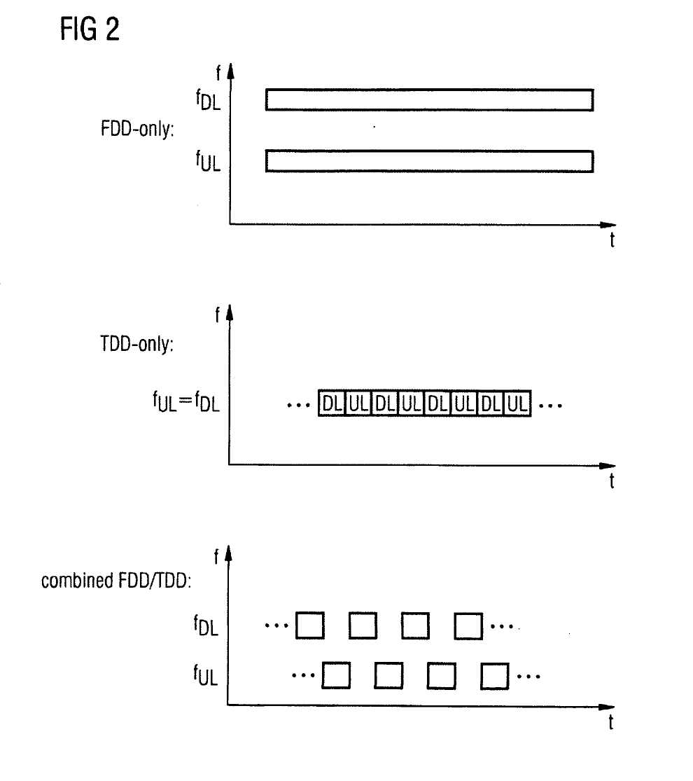

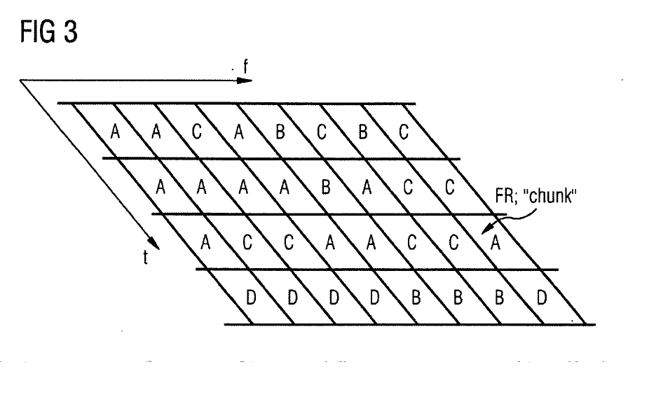

FIG. 1 shows a division and allocation of radio transmission resources FR according to the method proposed by the inventors. A total of twelve subcarriers ST1 to ST12 are available for a radio transmission. In this arrangement, the subcarriers ST1 to ST12 are subdivided into three speed ranges GB1, GB2 and GB3 as radio transmission resources.

The subcarriers ST1 to ST4 are allocated to a first speed range GB1 and are used for radio transmissions of subscribers, the individual speed v1 of whom corresponds to an interval from 0 km/h to 15 km/h.

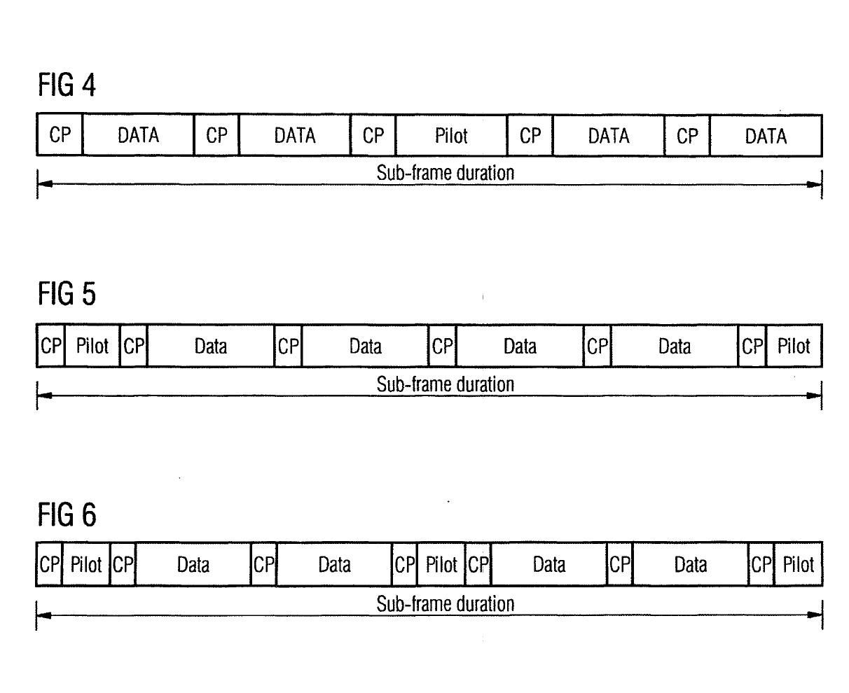

To the subcarriers ST1 to ST4, a first frame structure RS1 is allocated which, for example, corresponds to the frame structure according to FIG. 4.

Due to its pilot signal, this frame structure is suitable for the comparatively low subscriber speeds.

The subcarriers ST5 to ST10 are allocated to a second speed range GB2 and are used for radio transmissions of subscribers, the individual speed v2 of whom corresponds to an interval from 15 km/h to 120 km/h.

A second frame structure RS2 which, for example, corresponds to the frame structure according to FIG. 5, is allocated to the subcarriers ST5 to ST10.

Due to its two pilot signals, this frame structure is suitable for the comparatively medium subscriber speeds.

The subcarriers ST11 and ST12 are allocated to a third speed range GB3 and are used for radio transmissions of subscribers, the individual speed v3 of whom corresponds to an interval from 120 km/h to 350.

A third frame structure RS3 which, for example, corresponds to the frame structure according to FIG. 6, is allocated to the subcarriers ST11 and ST12.

Due to its three pilot signals, this frame structure is suitable for the comparatively high subscriber speeds.

The individual speed of progress of a subscriber can be determined, for example, with the aid of a signal propagation measurement (determination of the time of arrival, TOA, between a transmitter and a receiver) or by successive determinations of position, if necessary by using GPS.

If a subscriber considered is, for example, a pedestrian, the first speed range GB1 is allocated to the subscriber. Useful data are then transmitted between the subscriber and a base station by using the first frame structure RS1 through one or through a plurality of the subcarriers ST1 to ST4.

If, however, the subscriber considered is a car driver on a freeway, he is allocated, for example, the third speed range GB3. Useful data are then transmitted between the subscriber and the base station by using the third frame structure RS3 through the subcarrier STI1 and/or through the subcarrier ST12.

The invention has been described in detail with particular reference to preferred embodiments thereof and examples, but it will be understood that variations and modifications can be effected within the spirit and scope of the invention covered by the claims which may include the phrase “at least one of A, B and C” as an alternative expression that means one or more of A, B and C may be used, contrary to the holding in Superguide v. DIRECTV, 69 USPQ2d 1865 (Fed. Cir. 2004).

1. (canceled)

2-15. (canceled)

16. A method for data transmission in a radio communication system, comprising:
combining data of a plurality of subscribers to form a plurality of frames by multiplexing and transmitting the frames via a plurality of subcarriers, wherein at least two different frame structures are provided for transmitting the frames, the frame structures differing in a respective allocated number of pilot signals and/or in a distribution of pilot signals, the pilot signals being provided for determining radio transmission channel characteristics;
determining a speed of progress of each subscriber and allocating each subscriber to one of at least two different speed ranges depending on the determined speed of progress; and
allocating a number of each of the subcarriers to each of the speed ranges, allocating one of the frame structures to each of the speed ranges such that each of the speed ranges has a different frame structure, and transmitting the data of each of the subscribers according to the allocated number of subcarriers and the allocated frame structure.

17. The method as claimed in claim 16, wherein subcarriers of an OFDM radio communication system are used for the data transmission.

18. The method as claimed in claim 17, wherein subcarriers, subdivided into time domains, of an OFDM radio communication system are used for the data transmission.

19. The method as claimed in claim 16, wherein the allocation of the frame structure to a speed range and/or the allocation of the number of subcarriers to a speed range is/are determined by a base station of the radio communication system.

20. The method as claimed in claim 16, wherein the allocation of subscribers to one of the speed ranges is determined by a base station of the radio communication system.

21. The method as claimed in claim 16, wherein a number of speed ranges and the respective boundaries of the speed ranges are determined by a base station of the radio communication system.

22. The method as claimed in claim 19, wherein the respective determination occurs adaptively and in dependence on a subscriber traffic load.

23. The method as claimed in claim 16, wherein pilot signals are transmitted in predetermined two time domains by a first frame structure of an associated first speed range.

24. The method as claimed in claim 23, wherein the pilot signals are transmitted as groups of a first length.

25. The method as claimed in claim 24, wherein pilot signals are transmitted in predetermined three time domains by a second frame structure of an associated second speed range.

26. The method as claimed in claim 25, characterized in that the pilot signals are transmitted as shortened groups of a second length.

27. The method as claimed in claim 26, wherein
the first frame structure is used for subscribers who are allocated to the first speed range due to their low individual subscriber speed, and
the second frame structure is used for subscribers who are allocated to the second speed range due to their higher individual subscriber speed.

28. The method as claimed in claim 16, wherein a channel estimation for an optimized transmission of useful data by subscribers is carried out by the pilot signals.

29. The method as claimed in claim 16, wherein useful data of a first and of a second subscriber, who are allocated to an identical speed range, are combined by a multiplexing method.

30. The method as claimed in claim 16, wherein an E-UTRA mobile radio system or an OFDM radio communication system is used as the radio communication system.
